(19) United States
(12) Patent Application Publication
(10) Pub. No.: US 2006/0056800 A1
(43) Pub. Date: Mar. 16, 2006

(54) Data recording apparatus

(76) Inventors: Kazuto Shimagami, Mito (JP); Atsuhiro Ono, Kitaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/194,530

(22) Filed: Aug. 2, 2005

(30) Foreign Application Priority Data
Sep. 15, 2004 (JP) 2004-267679

(51) Int. Cl. H04N 5/781

(52) U.S. Cl. 386/52; 386/125

(57) ABSTRACT

It is necessary to provide a data recording apparatus that records a digital broadcast and facilitates the editing of recorded data. It is also necessary to provide a data recording apparatus that makes it possible to achieve high-quality playback of edited data with increased ease. In accomplishing these and objects, there is provided a data recording apparatus for recording a digital broadcast. The data recording apparatus comprises first recording means for recording externally input stream data, which is in transport stream (TS) format, onto a recording medium, and second recording means for generating data in program stream (PS) format in accordance with the TS format data and recording the generated PS format data onto the recording medium. The PS format data is edited in such a manner that the associated editing information is reflected in TS format data playback.

### CLAIM OF PRIORITY

The present application claims priority from Japanese application serial no. P2004-267679, filed on Sep. 15, 2004, the content of which is hereby incorporated by reference into this application.

### BACKGROUND OF THE INVENTION

The present invention relates to an apparatus that is suitable for processing contents data, for instance, of a digital broadcast program.

The MPEG2 standard provides two types of streams. One is an MPEG-transport stream (hereinafter referred to as the TS), which is a multiplexing/separation method having a multiprogram handling capability. The other is an MPEG-program stream (hereinafter referred to as the PS), which uses storage media to record a program that is based on one movie, music, or drama broadcast.

As is the case with MPEG-1, the PS composes a single program within one stream. It is assumed that the PS is used for data transmission and storage in an environment where no error occurs. Further, the PS can reduce the degree of redundancy. Therefore, the PS is used with DVDs and other digital storage media that use a powerful error correction code.

On the other hand, the TS can compose a plurality of programs within one stream. Therefore, the TS can handle broadcasts and the like. It is assumed that the TS is used for broadcasts and in a communication network or other environment where a data transmission error may occur. The degree of redundancy is greater than when the PS is used. The TS is used in a communication path in which the transmission rate is fixed (the PS may be used at a variable transmission rate). The TS may be practically applied to CS and BS digital broadcast, U.S. DTV, and digital VTR systems.

As a recording method for recording the aforementioned PS format stream, a video recording method (hereinafter referred to as the VR method) is used. For the video recording method, the file structure is standardized so that editing and deleting operations can be performed in arbitrary increments. The TV broadcast information body and the like are received and recorded on an optical disk in real time. Further, playback control information concerning the information body (hereinafter referred to as the VR management information) is generated. The generated VR management information is saved in a file separate from the file for the information body and recorded on a recording medium. Therefore, the employed file structure permits the VR method to easily edit recorded content information. A technology concerning VR method recording is disclosed by Japanese Patent Laid-Open No. 242721/2003.

Further, the technology for recording TS format streams of a BS digital broadcast or the like in TS format and converting the TS format streams into PS format streams for recording onto a DVD or the like is disclosed by Japanese Patent Laid-Open No. 111023/2003.

### SUMMARY OF THE INVENTION

However, when TS format and PS format stream data (TS data/PS data) were to be edited in a situation where TS format and PS format recording operations were simultaneously performed, the TS format and PS format streams were separately recorded in the past so that adequate user friendliness was not provided. Further, it was not easy, for instance, to edit TS format stream data.

Under the above circumstances, the present invention has been made to facilitate TS/PS format parallel recording operations. Further, the present invention has been made to provide increased ease, for instance, of editing TS format stream data.

In solving the above problem, according to one aspect of the present invention, there is provided a data recording apparatus for digital broadcast recording, the data recording apparatus comprising recording means for recording stream data, which is entered from the outside as transport stream (TS) format data, onto a recording medium; and recording means for generating program stream (PS) format data in accordance with TS format data and recording the generated PS format data onto a recording medium. Control is exercised so as to read a PS format stream from the recording means at the time, for instance, of stream editing or dubbing and read a TS format stream from the recording means at the time, for instance, of stream playback.

According to another aspect of the present invention, there is provided a data recording apparatus comprising first recording means for recording externally input content onto a recording medium as first data; generation means for generating second data, which differs from the first data in format; second recording means for recording the second data onto the recording medium; and control means, which, when the content is to be played back, exercises control so as to output the first data from the recording medium, and when the content is not to be played back, exercises control so as to output the second data from the recording medium.

Further, when PS format stream data is edited, the editing information about the PS format is reflected in a TS format stream data playback.

According to another aspect of the present invention, there is provided a data recording apparatus comprising first recording means for recording externally input content onto a recording medium as first multiplexed stream data; generation means for generating second multiplexed stream data, which differs from the first multiplexed stream data, from the first multiplexed stream data; second recording means for recording the second multiplexed stream data onto the recording medium; editing means for editing the second multiplexed stream data; and reflection means for reflecting the editing results of the second multiplexed stream data, which is edited by the editing means, in the first multiplexed stream data.

To solve the aforementioned problem, it is also necessary to form a configuration in which TS format stream data is provided with its editing information to permit TS format data editing. In forming such a configuration, according to still another aspect of the present invention, there is provided a data recording apparatus comprising editing information addition means for adding editing information to stream data multiplexed in MPEG-TS format; editing means for editing the stream data; write means for writing the information edited by the editing means within the editing information; and recording means for recording the stream data and the editing information.

The present invention facilitates TS/PS format parallel recording operations. Further, the present invention provides increased ease, for instance, of editing TS format stream data.

### BRIEF DESCRIPTION OF THE DRAWINGS

FIG. 1 is a block diagram illustrating the overall configuration of a data recording apparatus according to one embodiment of the present invention;

FIG. 2 shows an example of a recording mode setup screen for TV broadcast program content data in accordance with one embodiment of the present invention;

FIG. 3 shows examples of chapters for TV broadcast program content data in accordance with one embodiment of the present invention;

FIGS. 4A to 4D illustrate typical editing and playback operations for TV broadcast program content data in accordance with one embodiment of the present invention;

FIG. 5 shows an example of a chapter setup screen for TV broadcast program content data in accordance with one embodiment of the present invention;

FIG. 6 shows an example of an editing screen for TV broadcast program content data in accordance with one embodiment of the present invention;

FIG. 7 is a flowchart illustrating a typical editing/playback operation for TV broadcast program content data in accordance with one embodiment of the present invention;

FIG. 8 illustrates a typical playlist editing screen for TV broadcast program content data in accordance with one embodiment of the present invention;

FIG. 9 illustrates a typical playlist listing screen for TV broadcast program content data in accordance with one embodiment of the present invention; and

FIG. 10 shows an example of commercial message automatic skip editing in accordance with one embodiment of the present invention.

### DETAILED DESCRIPTION OF THE PREFERRED EMBODIMENTS

Embodiments of the present invention will now be described in detail with reference to the accompanying drawings.

### First Embodiment

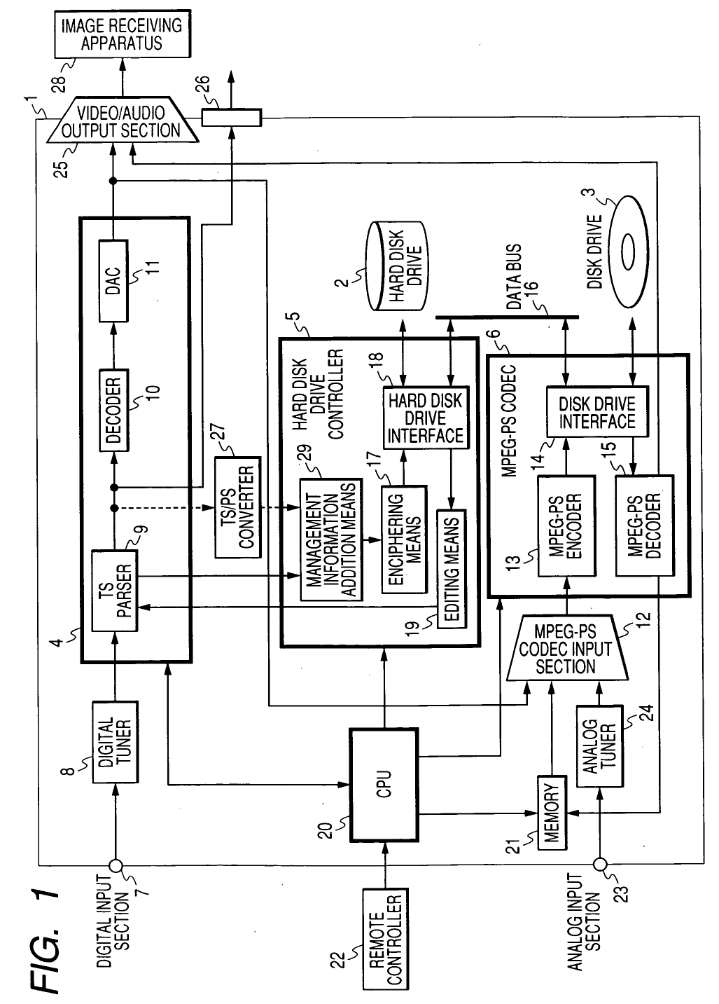

FIG. 1 is a block diagram illustrating the overall configuration of a data recording apparatus according to one embodiment of the present invention. The data recording apparatus 1 includes a hard disk drive 2 and a disk drive 3 that drives a DVD or other removable medium. The data recording apparatus 1 also includes a digital input section 7, an analog input section 23, a digital tuner 8, an analog tuner 24, a decoding section 4, a CPU 20 for exercising stream recording/editing/playback control, a hard disk drive controller 5 for recording onto the hard disk drive, an MPEG-PS codec 6 having an encoder function for compressing video and audio data into a PS stream and a decoder function for decompressing a compressed PS stream into video and audio data, a memory 21, a data bus 16, and a video/audio output section 25.

The decoding section 4 includes a TS parser 9 for demultiplexing and deciphering a stream that is multiplexed and enciphered by a transmitting station, a decoder 10 for decoding an encoded stream, and a DAC 11 for converting a digital signal to an analog signal. The hard disk drive controller 5 includes management information addition means 29 for adding management information, which is stream editing information, to a stream, enciphering means 17 for enciphering a stream for copy protection, editing means 19 for editing a TS stream, and a hard disk drive interface 18. The MPEG-PS codec 6 includes an MPEG-PS encoder 13, an MPEG-PS decoder 15 and a disk drive interface 14.

The present embodiment receives user-selected content from the digital tuner 8 and records the content on the hard disk drive 2 in both the TS format and PS format. First of all, the operation for recording a TS format stream onto the hard disk drive 2 from the digital turner 8 will be described. The TS format is used, for instance, by a broadcast system that distributes a plurality of broadcast programs and by a receiver and digital VTR that are included in the broadcast system. The TS format is used, for instance, for high-definition broadcast or other high-quality image transmission. Therefore, when the TS format is used for recording purposes, it is possible to achieve high-quality image reproduction.

A digital broadcast signal, which is received by an antenna (not shown), is output to the digital tuner 8 via the digital input section 7. The digital tuner 8 performs a demodulation/error correction process and outputs a TS format multiplexed stream to the TS parser 9. The TS parser 9 demultiplexes the stream. If the stream is enciphered by a transmitting station, the TS parser 9 also deciphers the stream. After the stream is processed in such a manner, it is forwarded to the management information addition means 29 within the hard disk drive controller 5. The management information addition means 29 adds TS management information, which is stream editing information, to the stream. The TS management information will be described later. After the TS management information is added to the stream, the stream is enciphered for copy protection by the enciphering means 17. The output from the enciphering means 17 is delivered to the hard disk drive 2 via the hard disk drive interface 18 and then recorded. As described above, the TS stream from the digital tuner 8 is recorded onto the hard disk drive 2 with the original format retained. When this recording scheme is employed, it is possible to achieve high-quality reproduction of a broadcast program that is recorded on the hard disk drive. Further, the hard disk drive has a large capacity and provides a high transfer rate. Therefore, the entire information contained in a TS can be recorded at a high speed and for a long period of time.

Next, the operation for recording onto the hard disk drive 2 from the digital turner 8 in PS format will be described. A digital broadcast signal, which is received by the antenna, is output to the digital tuner 8 via the digital input section. The digital tuner 8 performs a demodulation/error correction process and outputs the processed signal to the TS parser 9. The MPEG stream from the digital tuner 8 is a TS format multiplexed stream. The TS parser 9 demultiplexes the processed signal. If the signal is enciphered by a transmitting station, the TS parser 9 also deciphers the signal. The signal is then forwarded to the decoder 10. The signal is decoded by the decoder 10 and then converted to an analog signal by the DAC 11. The resulting analog signal is delivered to the MPEG-PS encoder 13 within the MPEG-PS codec 6 via an MPEG-PS codec input section 12. The MPEG-PS encoder 13 encodes the signal into a PS format stream and adds VR management information to the stream as the editing information about the stream. After the VR management information is added to the PS stream, the PS stream is recorded onto the hard disk drive 2 via the disk drive interface 14, data bus 16, and hard disk drive interface 18. As described above, the TS format stream received by the digital tuner 8 is converted into the PS format and recorded onto the hard disk drive 2. In a series of processes described above, the DAC 11 converts a digital signal to an analog signal. However, the image quality of the video signal may be adjusted after completion of such a conversion process. More specifically, analog image quality adjustments such as edge enhancement, brightness correction, and contrast adjustment may be made. For TS-to-PS format conversion purposes, the present embodiment down-converts a digital broadcast to an analog signal and then encodes the resulting signal into the PS format. However, a TS/PS converter may be used as indicated by the broken lines in FIG. 1 so that TS-to-PS format conversion is effected with a digital signal delivered from the decoding section to the hard disk drive controller as is. In such an instance, the management information addition means 29 within the hard disk drive controller adds VR management information to the PS stream.

As described above, a VR recording method, which facilitates stream editing, can be used for PS format recording. Therefore, PS format recording is advantageous in that ease of stream editing is provided. Further, PS format recording is suitable for high-speed dubbing onto a DVD or other storage medium. The term “high-speed dubbing” refers to an operation that is completed to copy data to a DVD or the like from a hard disk drive within a period of time that is several times shorter than the normal stream playback time. When data is recorded onto a hard disk drive in the TS format, it is necessary to perform a step for converting TS format data to PS format data because the PS format is employed for DVD recording. Consequently, high-speed dubbing is difficult to achieve.

When data is simultaneously recorded onto the hard disk drive in both the TS and PS formats, the data recording apparatus according to the present embodiment exercises control so that a TS format stream and PS format stream are selectively used in accordance with a user-selected function. When, for instance, data is to be dubbed onto a DVD, the hard disk drive outputs a PS format stream, which permits high-speed dubbing. Further, when stream editing is to be performed, the hard disk drive outputs a PS stream that can be readily edited. However, when a stream is to be displayed, the hard disk drive outputs a TS format stream for display purposes because the TS format stream provides high-quality image display.

In other words, when the user performs a procedure for recording a desired broadcast program (content), the data recording apparatus automatically records PS format data and TS format data at the same time. For recording result display purposes, the data recording apparatus simply displays the name of recorded content without displaying both the PS format and TS format, causing the user to become aware that the desired content has been recorded. Then, the data recording apparatus automatically uses PS and TS format streams selectively in accordance with a user-selected function (editing, dubbing, or display), and generates an output, thereby offering an optimum environment without causing the user to become conscious of the PS format or TS format. Consequently, the user is saved the trouble of distinguishing between the PS format and TS format. In addition, the format selection function can be exercised to provide a high speed for dubbing, increased ease of editing, and high-quality display of a reproduced image.

The user is merely conscious of one piece of content without distinguishing between the TS and PS formats. Therefore, when PS format stream editing is performed, it is important that the editing result be reflected in a TS format stream, and that the result of reflection be output at the time of playback. Such importance holds true for the provision of increased ease not only in the present embodiment but also in other situations where the user knows that TS and PS format data are simultaneously recorded, and displays both recording results.

The user is satisfied when the user can edit TS format content recorded on the hard disk drive and view the editing result in a high-definition mode or other high image quality mode. However, it is difficult to directly edit a TS format stream because the TS format stream has a data structure suitable for communication media. The present embodiment, therefore, uses both the TS format, which provides high-quality playback, and the PS format, which provides increased ease of editing, for simultaneous recording onto the hard disk drive, uses the PS type stream for editing purposes, reflects PS format stream editing result in TS format playback, and eventually offers an edited, high-quality TS-format stream to the user. The use of this method makes it possible to perform editing with ease and achieve high-quality image playback.

Stream data (PS data/TS data) editing and playback will now be described in detail. First of all, editing of PS data stored on the hard disk drive 2 will be described. When the user operates a remote controller 22 to issue editing instructions, a target PS format stream is read via the hard disk drive interface 18, data bus 16, and disk drive interface 14, decoded by the MPEG-PS decoder 15, and temporarily stored in the memory 21. Then, the user operates the remote controller to perform editing operations, for instance, for chapter creation, division, deletion, addition, and rearrangement. The CPU rewrites the signal, which is temporarily stored in the memory, in accordance with editing information. In this instance, the VR management information, which manages the PS data editing information, is read from the hard disk drive 2 in the same manner as for the PS format stream, and rewritten in accordance with the editing information. The edited signal and VR management information are delivered to the MPEG-PS codec input section 6, encoded by the MPEG-PS encoder 13, and recorded onto the hard disk drive 2 via the disk drive interface 14, data bus 16, and hard disk drive interface 18. The PS data is edited as described above.

Next, the process for ensuring that the result of PS data editing, which has been performed as described above, is reflected in TS playback. When the user issues instructions for playing back edited content (stream), the editing means in the data recording apparatus reads TS data from the hard disk drive 2 via the hard disk drive interface 18 for the purpose of playing back a TS format stream as described earlier. The CPU 20 then exercises control so that the TS management information, which relates to the management of TS data editing information, is read in the same manner from the hard disk drive 2, and that the VR management information about the same selected pieces of content is also read from the hard disk drive. More specifically, the PS and TS format streams for the same simultaneously recorded pieces of content are associated with each other and stored so as to read the VR management information that is possessed by the associated PS format stream.

In accordance with the VR management information, the portion of the TS management information that is targeted for editing is rewritten. After the TS management information is updated by the editing means 19, the resulting TS data is forwarded to the TS parser 9 in the decoding section 4. The decoder 10 then decodes the TS data into video and audio signals. After the signals are converted to analog signals by the DAC 11, they are output by the video/audio output section 25 for playback purposes. The signals output by the video/audio output section 25 for playback purposes are displayed by a TV or other image receiving apparatus 28. When, for instance, a PS format stream is subjected to chapter editing, the editing result is also set in the TS management information. In a TS display operation, for instance, a selected chapter can be displayed in accordance with the management information.

As described above, the TS data is edited in accordance with the PS data editing result, and the stream is subjected to TS playback in accordance with the TS data editing result. Even if the TS data cannot readily be edited directly, TS playback can be achieved when the PS format editing result is reflected. In the present embodiment, the VR management information is reflected in the TS management information at the time of TS data playback. Alternatively, however, the VR management information may be reflected in the TS management information upon completion of PS data editing.

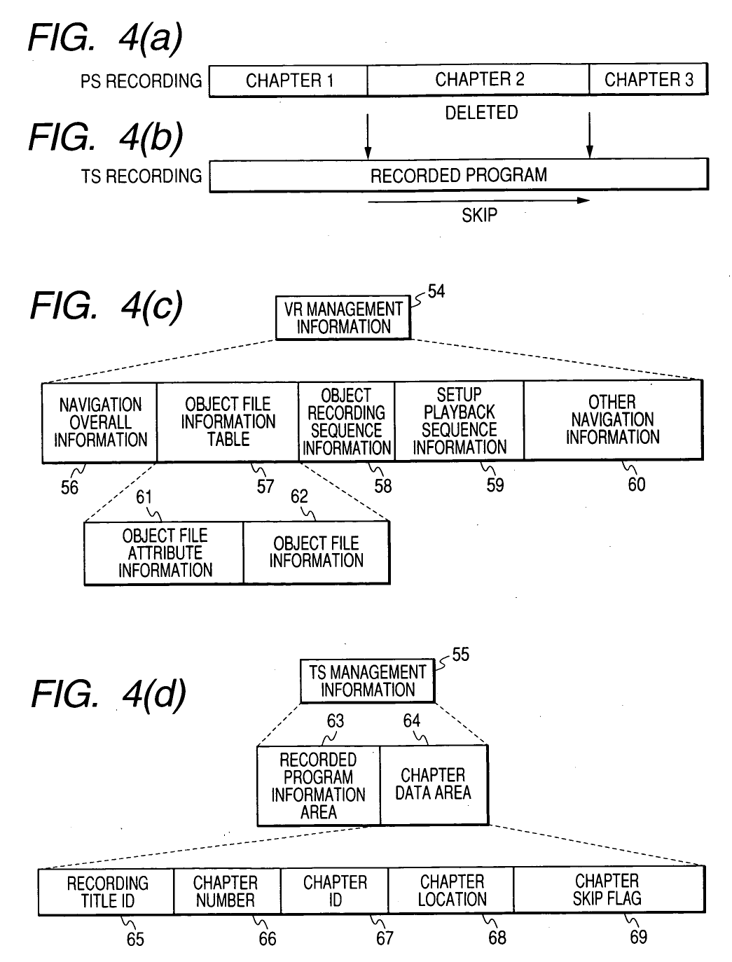

The aforementioned editing function and editing reflection function will now be described in detail with reference to FIGS. 3, 4A, 4B, 4C, and 4D. An example of chapter setup/deletion will be described below.

FIG. 3 shows typical chapters for TV broadcast program content data in accordance with the present embodiment. In FIG. 3, the reference numeral 41 denotes a chapter that prevails after broadcast program recording. FIG. 4A shows a PS stream that includes chapters 1, 2, and 3. FIG. 4B shows a TS stream that is recorded simultaneously with the PS stream. FIG. 4C shows the details of the VR management information that is used to manage the PS stream editing information and the like. FIG. 4D shows the details of the TS management information that is used to manage the TS stream editing information and the like. The VR management information 54 is playback control information for controlling the playback aspect of content information. The VR management information 54 comprises navigation overall information 56 for managing, for instance, an information table storage location within the VR management information, an object file information table 57, an object recording sequence information 58 for indicating what items of content information are recorded in what sequence at the beginning of recording as corresponding video objects (VOBs), setup playback sequence information 59 which comprises one or more pieces of playback procedure information that are generated and recorded by the user in order to combine all or some recorded pieces of content for logical playback purposes, and other navigation information 60 which is information necessary for playback control in addition to the aforementioned items of navigation information.

The object file information table 57 comprises object file attribute information 61 and object fie information 62. The object file attribute information 61 contains the types of content to be recorded and the attribute information about the content types. The object file information 62 contains the playback start time and playback end time of each piece of content, that is, the playback start time and playback end time of each piece of content for which the starting point of reckoning is the beginning of content, and the information related to the playback start time and playback end time (total number of chapters and chapter IDs).

The TS management information 55 includes a recorded program information area 63 in which the information about a recorded broadcast program is written, and a chapter data area 64 in which the information about broadcast program editing is written. The chapter data area 64 contains a recording title ID 65, which is an ID unique to a recording file; a chapter number 66, which is an already set chapter number; a chapter ID 67, which is a file name determination variable according to a stationary chapter point; a chapter location 68 (chapter start time and end time), which indicates the chapter point position with a frame; and a chapter skip flag 69, which is a flag indicating whether or not to skip a chapter at the time of playback.

After content recording, the user operates the remote controller 22 to divide one broadcast program into a plurality of chapters to the user's taste as indicated by the reference numeral 42 in FIG. 3. Chapters are set up in this manner. In this instance, the VR management information 54, which is the PS format stream editing information, is rewritten. More specifically, the information about the chapter start time, chapter end time, chapter number, chapter ID, and the like, which is written as the object file information 62, is updated. Setting the chapters as described above offers the advantage of quickly playing back a program from a user's favorite location. Meanwhile, the chapters can be deleted in like manner. Chapter deletion occurs when the remote controller 22 is operated to perform a chapter deletion procedure. When the user issues chapter deletion instructions, the chapters are deleted from a stream that is recorded in PS format. In this instance, too, the object file information 62 within the VR management information 54 is rewritten. Further, when the chapter deletion procedure is performed, the setup playback sequence information 59 is rewritten so that the stream will be played back while skipping the deleted chapters.

Next, when instructions for playing back content for which chapter setup has been performed by the user are received, a TS format stream in which a PS format editing result is reflected is played back without playing back an edited PS format stream. Therefore, the user can enjoy high-quality TS playback.

When instructions for playing back an edited chapter are issued, the CPU rewrites the TS management information 55, which is used to manage the TS data editing information, in accordance with the VR management information 54, so as to reflect the PS format editing results in the TS format data. More specifically, the chapter location 68, which indicates the chapter start time and end time within the TS management information, is rewritten in accordance with the chapter start time and end time written as the object file information 62, which is within the PS management information (VR management information). As far as the time used with the PS management information (VR management information) is equal to the time used with the TS management information, mere copying of each time value will suffice. If the units of time differ, it goes without saying that conversion needs to be effected in accordance with such a difference.

Further, the chapter number 66 and chapter ID 67 in the TS management information are rewritten in accordance with the chapter number and chapter ID that are written as the object file information 62 within the PS management information (VR management information). The TS management information rewritten in the above manner is used to perform TS playback of content for which chapter setup has been performed.

A case where the user issues instructions for deleting chapter 2 will now be described. When chapter 2 of a stream that is recorded in PS format is deleted, the VR management information 54, which is used to manage the PS data editing information, is rewritten as described earlier. When instructions for playing back TS data that corresponds to the PS data are issued, the CPU rewrites the TS management information 55, which is used to manage the TS data editing information, in accordance with the VR management information 54. In this instance, the TS format stream is not deleted. The deleted chapter is identified in accordance with the setup playback sequence information 59, which is placed within the VR management information 54 to define the chapters to be played back, and a chapter skip flag 69 is set within the TS management information 54 to skip chapter 2. In this instance, the chapter number 66, chapter ID 67, and chapter location 68 (chapter start time and end time) are not rewritten.

When the TS management information within which the chapter skip flag 69 is rewritten is used, the TS data is played back while skipping a portion corresponding to PS format chapter 2 (FIGS. 4A to 4D). The term “skipping” means that the portion is not played back because it is skipped. It does not mean that the portion is deleted. In reality, the TS format stream may be deleted. In the present embodiment, however, the stream is not deleted because a skipping function can be exercised simply by processing the management information.

Meanwhile, TS format stream editing needs to be performed, for instance, for chapter setup purpose in the unit of a group of pictures (hereinafter referred to the GOP). Therefore, if the aforementioned VR management information about PS data is merely reflected in the TS management information, the user may set up a chapter in the middle of a GOP, thereby incurring the generation of a block noise at the time of playback. As such being the case, the present embodiment exercises setup control by performing a computation process so that a chapter point is placed at a picture data position at the nearest GOP boundary. Each GOP is 0.5 second long. Therefore, if, for instance, the chapter start time is 40.2 seconds from the beginning of content, the chapter start time is set at a 40.0 second position. However, ease of processing may be considered while disregarding the picture data at the nearest boundary. Setup control may be alternatively exercised by performing a computation process so that the picture data at the next GOP boundary or at the previous GOP boundary is targeted.

As described above, content that is edited in PS format can be reflected in a high-quality TS format and played back. Further, TS playback can be achieved without incurring block noise.

FIG. 5 shows an example of a chapter setup screen for TV broadcast program content data in accordance with the present embodiment. A typical chapter setup operation will now be described with reference to FIG. 5. The chapter setup screen displays a playback mark 71 for indicating a selected playback mode; a playback screen 72 for displaying the currently played content; a current time display area 73; a playback time display area 74; a playback point 75 for indicating the current playback location; a mark 76 for indicating a scene that is to be skipped; a chapter point 77 for indicating the position of a boundary between one chapter and another; broadcast program recording time 78; a selection indicator 79 for displaying a thick outline indicating a point that is selected with a cursor button on the remote controller (not shown); a skip mark 80, which uses an icon to indicate a scene that is to be skipped; and a registered chapter start screen 81. When the user operates the remote controller 22 to issue instructions for chapter creation, the chapter setup screen (FIG. 5) opens. Next, the user operates remote controller buttons (play, search/slow, pause, skip/frame-by-frame advance, etc.), which are not shown, selects a scene of the program that is to be displayed within the playback screen 72 and subjected to chapter setup. When the user presses the Apply button on the remote controller (not shown), the selected scene is registered as a chapter point 77.

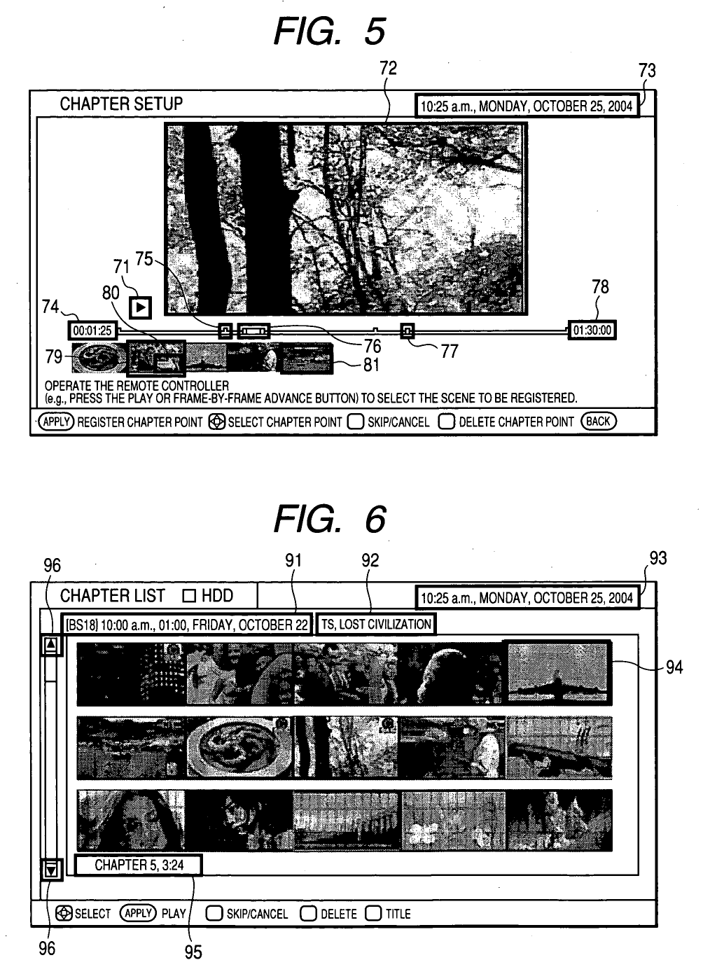

FIG. 6 shows a typical chapter list display screen for a stream that is recorded on the hard disk drive. This screen displays a PS format stream. A typical chapter deletion operation will now be described with reference to FIG. 6. The chapter list display screen contains an area 91 for displaying the recorded program date, start time, recording time, and channel; an area 92 for displaying the recording mode and program title; a current time display area 93; a chapter display area 94 for displaying various chapters; an area 95 for displaying the selected chapter number and time; and an area 96 for displaying a page switching bar. First of all, the chapter list display screen (FIG. 6) opens upon instructions from the remote controller 22. Next, the user operates the remote controller 22 to select a chapter that is to be deleted from the chapter display area 94. The selected chapter is then deleted.

When the above procedure is performed, the user-designated chapter is deleted or otherwise edited. This editing process is performed for PS format stream editing purposes. In the present embodiment, the editing result is reflected in TS playback as described with reference to FIGS. 4A to 4D.

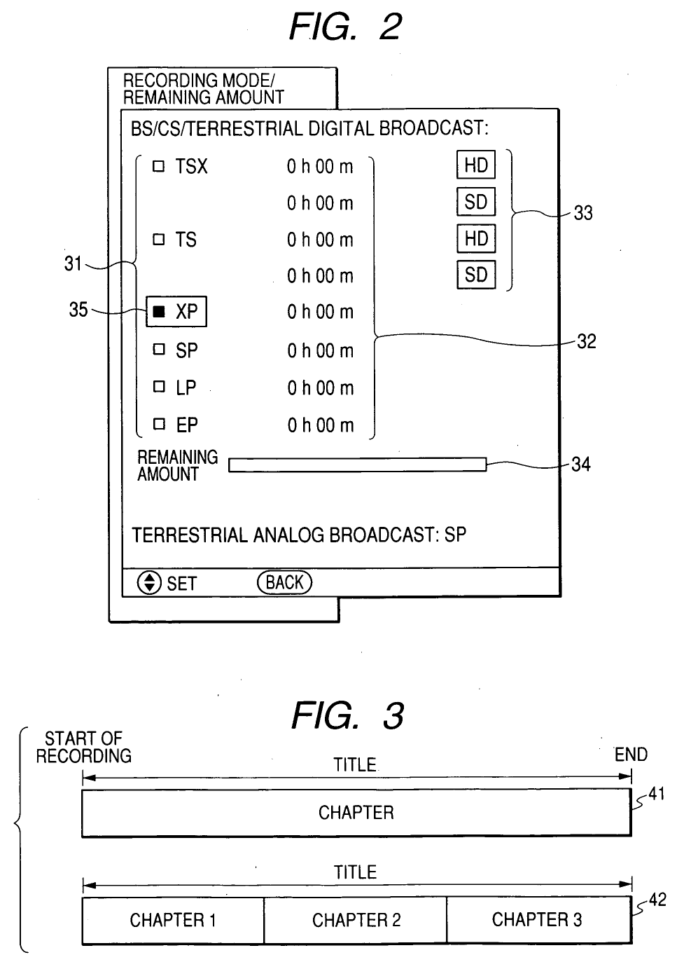

FIG. 2 shows a typical recording mode selection screen that is used when a digital broadcast is to be simultaneously recorded in both the TS format and PS format. This screen allows each user to select a recording mode according to his/her taste. A “recording mode/remaining amount” display screen, which is shown in FIG. 2, displays recording modes 31 that can be selected by the user, available recording time 32 for a selected recording mode, an image quality indication 33, and a remaining hard disk space display bar 34. The HD mark for the image quality indication 33 means that high-definition playback is achievable. The SD mark for the image quality indication 33 means that standard-definition playback is achievable. The recording modes 31 differ in recording stream type. The TSX mode is a mode in which a stream is recorded in both the TS format and PS format. The TS mode is used for TS format recording. The XP, SP, LP, and EP modes are used for PS format recording. The XP, SP, LP, and EP modes differ in recording bit rate. From the highest recording bit rate to the lowest, the recording modes are XP, SP, LP, and EP. High-definition playback is achievable when a high bit rate is used. However, when a low bit rate is used for recording, the available recording time is long. The EP mode provides the longest recording time. The remote controller 22 shown in FIG. 1 is used for mode selection. A cursor 35, which is shown in FIG. 2, is moved up or down to select a desired mode. If the user intends to perform parallel recording in both the TS and PS formats, the user should select the TSX mode.

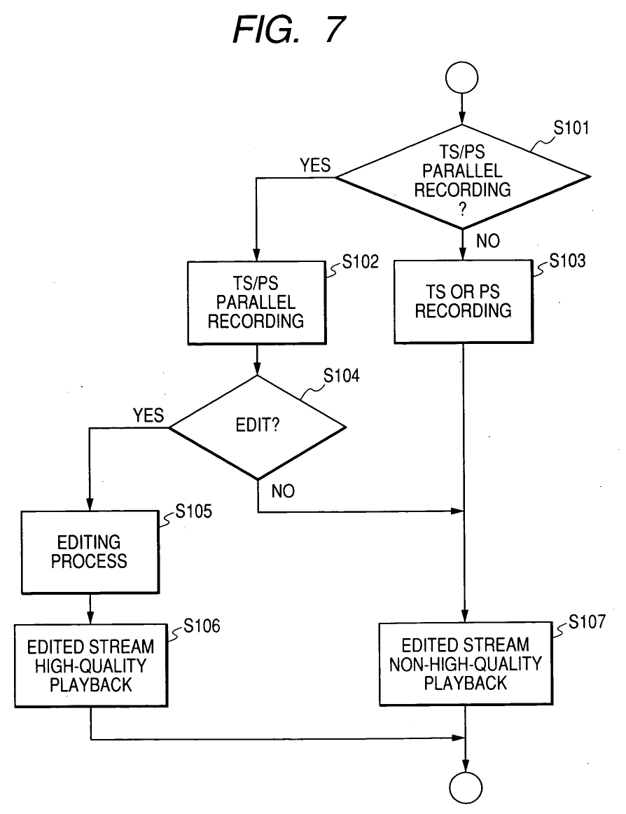

FIG. 7 is a flowchart illustrating typical operations that the data recording apparatus 1, which is shown in FIG. 1, performs to simultaneously record the content data of a digital broadcast program in the TS and PS formats, edit the content data, and play back the content data in TS format.

Referring to FIG. 7, step S101 is first performed to judge whether the user has selected the TSX mode as a digital broadcast recording mode (see FIG. 2), that is, the user has made a request for parallel TS/PS format recording. If the obtained judgment result indicates that parallel TS/PS format recording has been requested (the query in step S101 is answered “YES”), parallel recording is performed in the TS and PS formats (step S102). Next, step S104 is performed to judge whether the user edits a recorded stream. If the obtained judgment result indicates that an editing request has been made (the query in step S104 is answered “YES”), the above content data is edited as described with reference to FIG. 5 (step S105). The information about the edited stream is then reflected in TS playback so that high-quality playback results (step S106).

If, on the other hand, the query in step S101 is answered “NO,” either a TS stream or PS stream is recorded. If the query in step S104 is answered “NO,” no editing is performed. The results of these processes are not reflected in PS-edited TS playback (step S107).

As described above, the present embodiment simultaneously records a PS format stream and TS format stream onto a recording medium, and exercises automatic control so as to output the PS format stream from the recording medium and use it for stream editing/dubbing and output the TS format stream from the recording medium and use it for stream playback. In this manner, a stream appropriate for a specific operation is automatically output so that the user can easily perform various operations without having to distinguish between the TS and PS formats.

Further, when PS format data is to be edited, the associated editing information is reflected in TS format data playback. This permits the user to enjoy an edited stream through high-quality TS playback. Especially, the necessity for performing an edit in the unit of a GOP is considered so that the TS management information is set up from chapter location information, which is set in the PS management information (VR management information).

In the present embodiment, the PS format stream editing result is reflected in TS format stream playback. However, it is possible to directly edit the aforementioned TS management information, which defines the relationship between various program IDs and chapter IDs. In this case, too, the necessity for performing an edit in the unit of a GOP is considered so that the chapter location information within the user-defined TS management information is set up in the GOP-specific position information. This makes it possible to enjoy block-noise-free, high-quality playback. In this instance, the TS management information is complicated. Therefore, when the above is considered, it is easier to rewrite the TS management information via the PS management information (VR management information).

When the user issues instructions for playback, the present embodiment automatically performs TS playback. However, an alternative configuration may be employed so that the user chooses between TS format playback and PS format playback.

Further, the data recording apparatus may alternatively include an external device output section 26 that receives a digital signal from the decoding section and directly outputs the received digital signal to an external device. The signal output from the external device output section 26 contains a stream that is recorded in the TS format and the TS management information in which PS format editing information is reflected. The external device output section 26 is used when, for instance, the TS stream stored on the hard disk drive is to be dubbed into an external device. If the handled digitally recorded program permits only one copy operation for copyright protection purposes, the data is not dubbed but moved so that the data is deleted from the hard disk drive.

In another alternative configuration, the TV or other image receiving apparatus 28 may be integral with the data recording apparatus 1.

### Second Embodiment

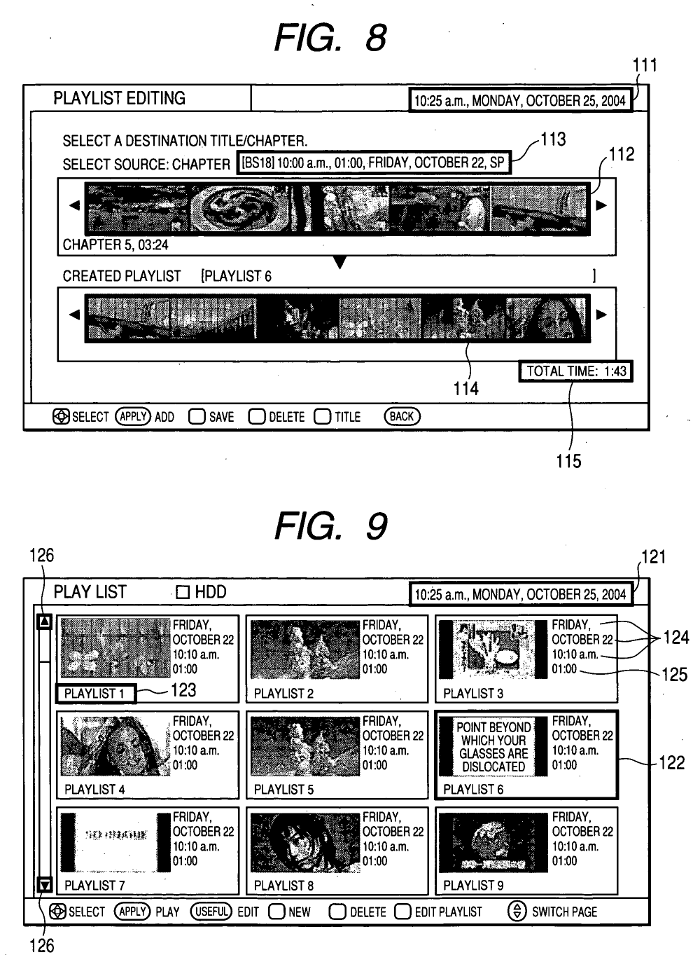

FIG. 8 illustrates a typical playlist editing screen that is used to edit TV broadcast program content data in accordance with a second embodiment of the present invention. A playlist is a collection of the user's favorite recorded scenes and used for editing. A user-selected chapter or the whole recorded program can be registered in the playlist. When the user operates the remote controller to issue instructions for playlist editing, a playlist editing screen (FIG. 8) opens. The playlist editing screen displays the current time 111, a selected program display area 112 for displaying the starting screen of each chapter within a selected program, a selected program information area 113 for displaying a selected program channel, date/time, recording mode, and title, a created playlist area 114 for displaying a created playlist, and a created playlist time display area 115. The user operates the remote controller 22 to select a chapter or recorded program, which is to be registered in the playlist, from the selected program display area 112. Playlist registration is then accomplished. A playlist can also be added or deleted.

FIG. 9 shows a playlist listing screen, which displays playlists that are registered in the manner described above. The playlist listing screen displays the current time 121, a playlist 122, a playlist title 123, a playlist creation date/time 124, a playlist playback date/time 125, and a page switching bar display area 126. The user can select a playlist 122 and play it back. It is possible to play back only one playlist or consecutively play back all playlists. The user can also play back user-selected, several types of playlists. If, for instance, playlists 1, 7, and 4 are selected, the present embodiment consecutively plays back playlists 1, 7, and 4 in order named. Playlist editing is PS data editing. Therefore, when editing information is reflected in TS playback as described with reference to FIGS. 4A to 4D, the playlists can be subjected to TS playback. Consequently, it is possible to enjoy high-quality playlist playback.

### Third Embodiment

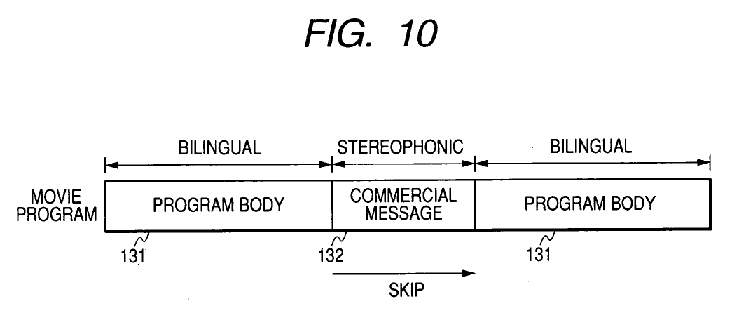

FIG. 10 shows an example of recorded stream editing for commercial message automatic skip playback. In the editing process described with reference to FIG. 1, the user directly operates the remote controller to perform edits. Once commercial message automatic skip setup is performed, a third embodiment automatically skips broadcast commercial messages. When, for instance, a movie is broadcast, a program body 131 is broadcast in bilingual mode whereas a commercial message 132 is broadcast in stereophonic mode. The CPU uses audio information decoded by the decoder 1, which is shown in FIG. 1, to judge the audio difference between the program body and commercial message. In accordance with the judgment result, the CPU automatically performs a PS data editing process. The PS data editing process and the process for reflecting the associated editing information in TS playback are the same as described with reference to FIGS. 4A to 4D. These processes save the user the trouble of directly deleting commercial messages, and the user can view a high-quality program without commercial messages. In the above example, the described editing process is performed to skip commercial messages in accordance with the audio difference between the bilingual broadcast and stereophonic broadcast. However, any audio difference will do. Further, the automatic editing process, which is based on an audio difference, need not always be performed to delete commercial messages.

While the present invention has been described in terms of preferred embodiments and their modified versions, their descriptions are to be considered in all respects only as illustrative and not restrictive. It should be understood that the present invention is not limited to those preferred embodiments and modified versions, and that variations may be made without departure from the scope and spirit of the present invention.

What is claimed is:

1. A data recording apparatus comprising:
a first recorder which records externally input content onto a recording medium as first data;
a generation unit which generates second data from the first data, the second data being different in format from the first data;
a second recorder which records the second data onto the recording medium; and
a controller which exercises control so as to output the first data from the recording medium in a case where the content is to be played back and exercises control so as to output the second data from the recording medium in a case where the content is not to be played back.

2. The data recording apparatus according to claim 1, the case where the content is not to be played back includes a situation where the content is to be edited or dubbed.

3. The data recording apparatus according to claim 1, wherein the first data is recorded in MPEG-TS format; and wherein the second data is recorded in MPEG-PS format.

4. The data recording apparatus according to claim 2, wherein the first data is recorded in MPEG-TS format; and wherein the second data is recorded in MPEG-PS format.

5. A data recording apparatus comprising:
a first recorder which records externally input content onto a recording medium as first multiplexed stream data;
a generation unit which generates second multiplexed stream data from the first multiplexed stream data, the second multiplexed stream data being different in multiplex format from the first multiplexed stream data;
a second recorder which records the second multiplexed stream data onto the recording medium;
an editor which edits the second multiplexed stream data; and
a controller which exercises control so as to output the first multiplexed stream data from the recording medium in a case where the content is to be played back and exercises control so as to output the second multiplexed stream data from the recording medium in a case where the content is to be edited or dubbed.

6. A data recording apparatus comprising:
a first recorder which records externally input content onto a recording medium as first multiplexed stream data;
a generation unit which generates second multiplexed stream data from the first multiplexed stream data, the second multiplexed stream data being different in multiplex format from the first multiplexed stream data;
a second recorder which records the second multiplexed stream data onto the recording medium;
an editor which edits the second multiplexed stream data; and
a reflecting unit which reflects the results of the second multiplexed stream data edited by the editor in the first multiplexed stream data.

7. A data recording apparatus comprising:
a first recorder which records externally input first data and the editing information about the first data onto a recording medium;
a generation unit which generates second data from the first data, the second data being different in format from the first data;
a second recorder which records the second data and the editing information about the second data onto the recording medium;
an editor which edits the second data;
a first rewriting unit which rewrites the editing information about the second data in accordance with the results of editing the second data; and
a second rewriting unit which rewrites the editing information about the first data in accordance with the second data editing information rewritten by the first rewriting unit.

8. The data recording apparatus according to claim 7, wherein the first data is played back in accordance with the first data editing information rewritten by the second rewriting unit.

9. The data recording apparatus according to claim 5, wherein the first multiplexed data is multiplexed in MPEG-TS format; and wherein the second multiplexed data is multiplexed in MPEG-PS format.

10. The data recording apparatus according to claim 6, wherein the first multiplexed data is multiplexed in MPEG-TS format; and wherein the second multiplexed data is multiplexed in MPEG-PS format.

11. The data recording apparatus according to claim 7, further comprising:
a first editing information addition unit which adds editing information to the first data; and
a second editing information addition unit which adds editing information to the second data.

12. The data recording apparatus according to claim 8, further comprising:
a first editing information addition unit which adds editing information to the first data; and
a second editing information addition unit which adds editing information to the second data.

13. The data recording apparatus according to claim 5, wherein the editing information about the first multiplexed stream data contains at least the information indicating the position of a boundary between chapters within the first multiplexed stream data.

14. The data recording apparatus according to claim 6, wherein the editing information about the first multiplexed stream data contains at least the information indicating the position of a boundary between chapters within the first multiplexed stream data.

15. The data recording apparatus according to claim 5, wherein the editing information about the first multiplexed stream data contains at least the information indicating whether or not to skip chapters within the first multiplexed stream data during stream playback.

16. The data recording apparatus according to claim 6, wherein the editing information about the first multiplexed stream data contains at least the information indicating whether or not to skip chapters within the first multiplexed stream data during stream playback.

17. A data recording apparatus comprising:
an editing information addition unit which adds editing information to stream data that is multiplexed in MPEG-TS format;
an editor which edits the stream data;
a writing unit which writes information edited by the editor into the editing information; and
a recorder which records the stream data and the editing information.

18. The data recording apparatus according to claim 7, wherein, in a situation where a chapter is deleted from the first data editing information, the second data editing information includes skip information for skipping the deleted chapter.
